(19) United States
(12) Patent Application Publication
(10) Pub. No.: US 2007/0145126 A1
(43) Pub. Date: Jun. 28, 2007

(54) System and method for increasing convenience of gasoline cash purchases

(75) Inventors: Boris Erlank, Walnut Creek, CA (US); Tod Thatcher, Concord, CA (US)

Correspondence Address: CHEVRON TEXACO CORPORATION, P.O. BOX 6006, SAN RAMON, CA, 94583-0806, US

(73) Assignee: Chevron U.S.A. Inc.

(21) Appl. No.: 11/317,943

(22) Filed: Dec. 22, 2005

(51) Int. Cl. G06F 7/08; G06K 5/00

(52) U.S. Cl. 235/381; 235/380; 235/382

(57) ABSTRACT

The invention includes a system for cash fuel purchases including: an identity product for issuance to cash customers and having machine-readable database key information encoded therein; a reader for reading the machine-readable database key information encoded on the identity product; a relational database for storing identifying information, transaction records, a discount indicator, and a status indicator for each of the cash customers issued an identity product, where the status indicator is used to approve or disapprove requested transactions, where each of the cash customer's identifying information is related in the database to the corresponding database key information encoded on each cash customer's issued identity product, where the database is in communication with the reader via a computer network; a transaction locking device for allowing a transaction to proceed upon unlocking; a transaction approval code segment loaded on a general purpose computer in communication with the reader via a network, the code segment adapted and configured for receiving a database key, passing it to the database, receiving the identifying information and status indicator, and approving or disapproving a transaction based on the status indicator, and passing the approval or disapproval to the transaction locking device, where the transaction locking device only unlocks upon receiving a transaction approval; a database update code segment loaded on the general purpose computer, the code segment adapted and configured for updating the transaction records with the most recent transaction, and updating the status indicator in the database for each customer after each transaction, where upon after a pre-determined number of transactions having payment defaults the status indicator is updated to a pre-determined indicator to cause a transaction disapproval upon the next transaction request, and updating the discount indicator where upon pre-determined transaction criteria, the transaction indicator is updated to a pre-determined indicator to cause the price per unit of fuel to change for the next requested transaction.

### COPYRIGHT NOTICE AND AUTHORIZATION

This patent document contains material that is subject to copyright protection.

(C) Copyright 2005 Chevron U.S.A. Inc. All rights reserved.

With respect to this material which is subject to copyright protection. The owner, Chevron Products Company, a division of Chevron U.S.A. Inc., has no objection to the facsimile reproduction by any one of the patent disclosure, as it appears in the Patent and Trademark Office patent files or records of any country, but otherwise reserves all rights whatsoever.

### FIELD OF THE INVENTION

This invention relates to system and method for increasing convenience of gasoline/fuel cash purchases.

BACKGROUND OF THE INVENTION

Automotive fuel customers, e.g., gasoline or diesel, typically purchase the fuel at a retail service station. In the United States, there are few full service stations remaining where an attendant fills the fuel tank and provides other services such as checking oil level and tire air pressure, and processes the payment, be it cash or credit card. Such full service, where the customer may remain seated in the vehicle has given way to self-service stations. Self-services stations allow the station to charge a much lower rate for the fuel since there is less labor cost.

With self-service, the customer must handle the payment. Presently many fuel pumps include a credit or debit card reader that permits the customer to pay at the pump. There is, however, usually no facility permitting cash payments at the pump. As a result, cash customers are greatly inconvenienced. Only very few stations have “cash acceptors,” i.e., devices or attendants, at the pump. For cash, a customer must go to where the cash register and clerk are located typically inside the associated convenience store or station office and not at the pumps. To avoid fuel theft, many fuel stations will not permit the cash customer to first pump the fuel into the vehicle and then, knowing the total sale, go to the cash register to make cash payment. Instead, the station will require the customer go to the cash register, clerk, and pay in advance. Then the clerk unlocks the fuel pump and the customer returns to the pump and pumps the fuel. Since a customer who fills his/her fuel tank cannot know the exact amount of fuel required to fill it, the customer typically will initially give the clerk a cash amount greater than the amount needed to fill the tank or a credit card as a security deposit. Then after completing the pumping, the customer will return to the cash register and clerk for change. Thus, to pay via cash, the customer must make two trips to the cash register. It would be desirable to have a system that allowed the customer to fill his/her tank, pay via cash, but only make one trip to the cash register. This is preferable for the station owner also since it requires less time and labor from the station employees and allows more customer volume to be processed and therefore potentially more sales volume.

For the station owner, cash is also a preferable form of payment because credit card payments incur additional costs. There are fees charged by the credit card issuer to the station owner and there are processing fees paid to a credit card processing service or incurred by the station owner if it does its own credit card purchase processing. It would be desirable to have a cash payment system that was convenient for the customer and provided an incentive for the customer to pay in cash rather than by credit card.

The method and system of the invention described herein provides a solution to the above-described problems.

### SUMMARY OF THE INVENTION

The invention includes a system for cash fuel purchases including: an identity product for issuance to cash customers and having machine-readable database key information encoded therein; a reader for reading the machine-readable database key information encoded on the identity product; a relational database for storing identifying information, transaction records, a discount indicator, and a status indicator for each of the cash customers issued an identity product, where the status indicator is used to approve or disapprove requested transactions, where each of the cash customer's identifying information is related in the database to the corresponding database key information encoded on each cash customer's issued identity product, where the database is in communication with the reader via a computer network; a transaction locking device for allowing a transaction to proceed upon unlocking; a transaction approval code segment loaded on a general purpose computer in communication with the reader via a network, the code segment adapted and configured for receiving a database key, passing it to the database, receiving the identifying information and status indicator, and approving or disapproving a transaction based on the status indicator, and passing the approval or disapproval to the transaction locking device, where the transaction locking device only unlocks upon receiving a transaction approval; a database update code segment loaded on the general purpose computer, the code segment adapted and configured for updating the transaction records with the most recent transaction, and updating the status indicator in the database for each customer after each transaction, where upon after a pre-determined number of transactions having payment defaults the status indicator is updated to a pre-determined indicator to cause a transaction disapproval upon the next transaction request, and updating the discount indicator where upon pre-determined transaction criteria, the transaction indicator is updated to a pre-determined indicator to cause the price per unit of fuel to change for the next requested transaction.

In another embodiment, the invention includes a method of increasing convenience and reducing cost for cash fuel purchases including: reading an identity product for issuance to fuel cash customers and having machine-readable database key information encoded therein; passing the database key information over a network to a relational database for storing identifying information, transaction records, a discount indicator, and a status indicator for each of the cash customers issued an identity product, where the status indicator is used to approve or disapprove requested transactions, where each of the cash customer's identifying information is related in the database to the corresponding database key information encoded on each cash customer's issued identity product, where the database is in communication with the reader via a computer network; receiving the status indicator over the network from the relational database by a transaction approval code segment loaded on a general purpose computer, the code segment adapted and configured for receiving a database key, passing it to the database, receiving the identifying information and status indicator, and approving or disapproving a transaction based on the status indicator, and passing the approval or disapproval to a transaction locking device, where the transaction locking device only unlocks upon receiving a transaction approval; unlocking the transaction locking device, thereby permitting the purchase of fuel by the cash customer; and updating a database update code segment with the purchase information, where the database update code segment is loaded on the general purpose computer, the code segment adapted and configured for updating the transaction records with the most recent transaction, and updating the status indicator in the database for each customer after each transaction, where upon after a pre-determined number of transactions having payment defaults the status indicator is updated to a pre-determined indicator to cause a transaction disapproval upon the next transaction request, and updating the discount indicator where upon pre-determined transaction criteria, the transaction indicator is updated to a pre-determined indicator to cause the price per unit of fuel to change for the next requested transaction. These and other features and advantages of the present invention will be made more apparent through a consideration of the following detailed description of a preferred embodiment of the invention. In the course of this description, frequent reference will be made to the attached drawings.

### BRIEF DESCRIPTION OF THE DRAWINGS

FIG. 1 is a context diagram depicting in one embodiment of the invention an organizational/environmental overview of the system of the invention, its boundaries, external entities that interact with the system, and the major information flows between the entities and the system.

FIG. 2 is schematic system diagram depicting in one embodiment of the invention showing its major components.

FIG. 3 is a level-0 data-flow diagram depicting in one embodiment of the invention the system's major processes, data flows, and data stores at a high level as applicable.

### DETAILED DESCRIPTION OF PREFERRED EMBODIMENTS

The major components (also interchangeably called aspects, subsystems, modules, functions, services) of the system and method of the invention, and examples of advantages they provide, are described below with reference to the figures. For figures including process/means blocks, each block, separately or in combination, is alternatively computer implemented, computer assisted, and/or human implemented. Computer implementation optionally includes one or more conventional general purpose computers having a processor, memory, storage, input devices, output devices and/or conventional networking devices, protocols, and/or conventional client-server hardware and software. Where any block or combination of blocks is computer implemented, it is done optionally by conventional means, whereby one skilled in the art of computer implementation could utilize conventional algorithms, components, and devices to implement the requirements and design of the invention provided herein. However, the invention also includes any new, unconventional implementation means.

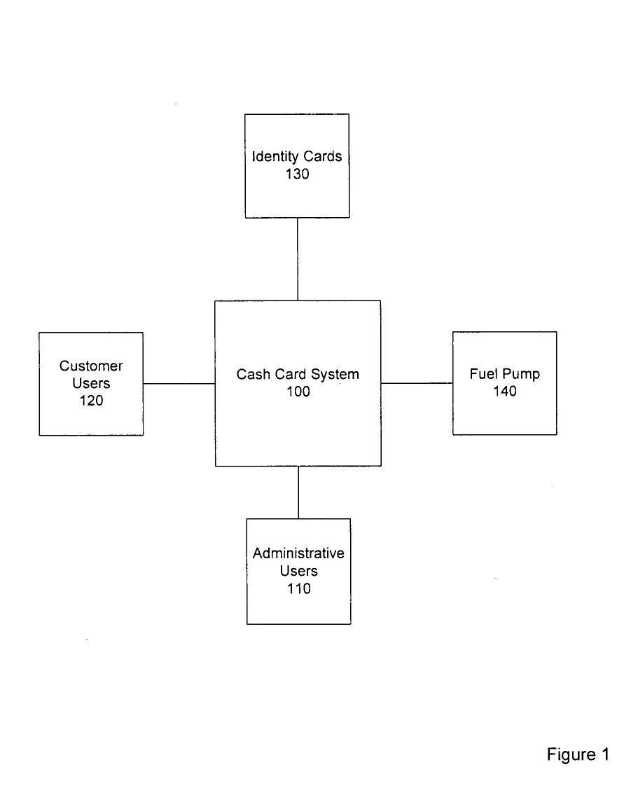

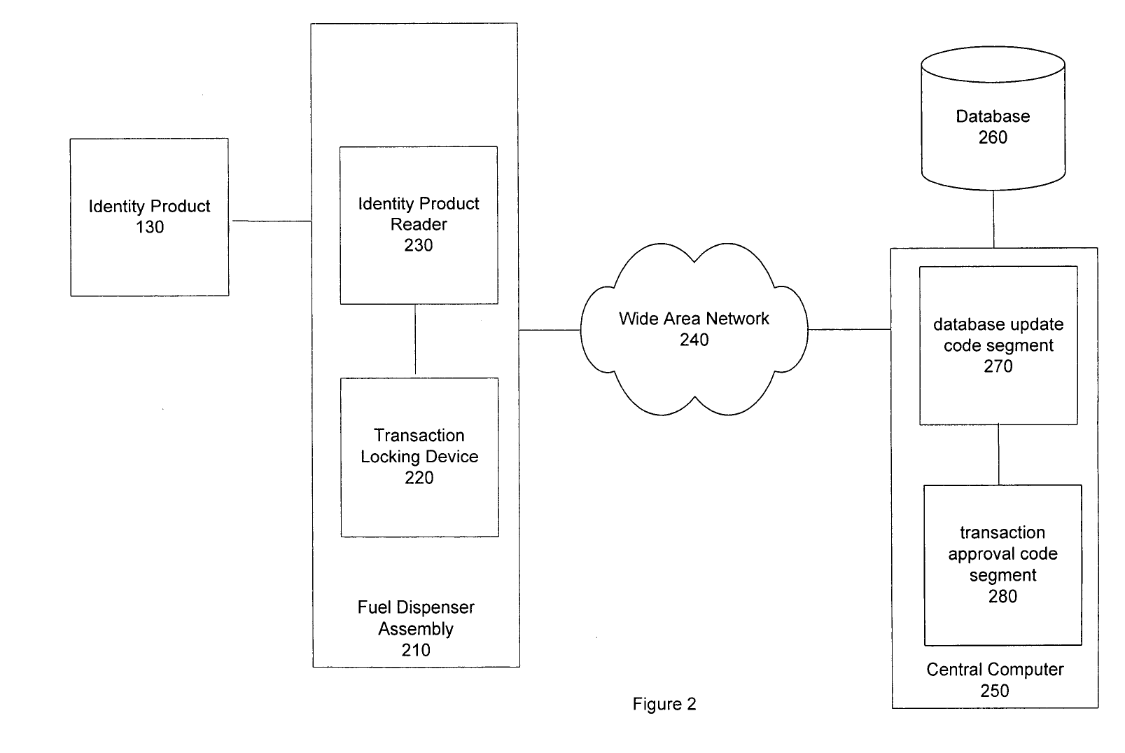

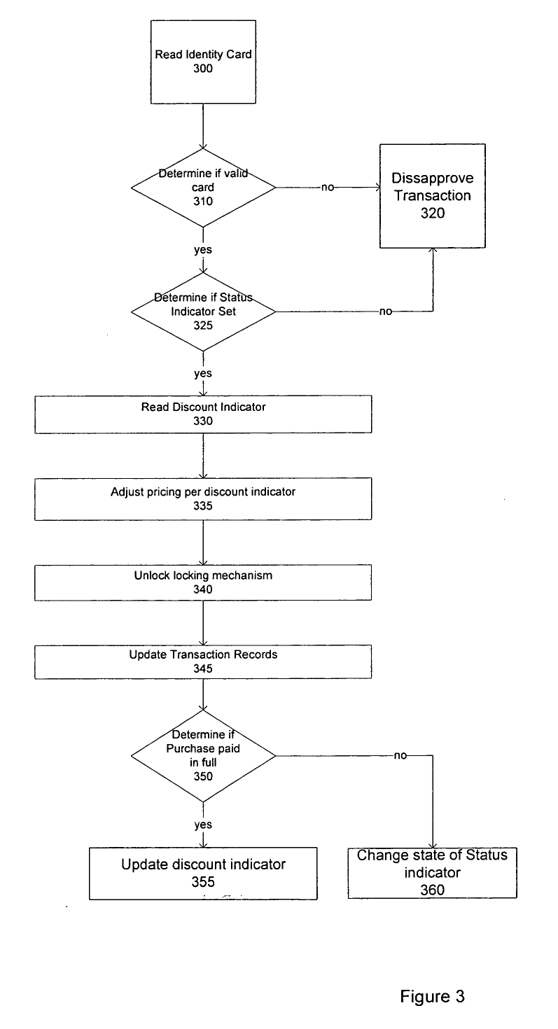

FIG. 1 is a context diagram depicting in one embodiment of the invention an organizational/environmental overview of the system of the invention, its boundaries, external entities that interact with the system, and the major information flows between the entities and the system. Cash Card System 100 interacts with Fuel Pump 140, Identity Cards 130, Customer Users 120, and Administrative Users 110. While the external entities are represented as single entities, it is understood each external entity is representative of potentially multiple components or entities in each. Identity Cards 130 are issued to and carried by Customer Users 120. The Identity Cards 130 are optionally issued by Administrative Users 110. Multiple instances of the Cash Card System 100 may be installed integral with, or operably connected with, multiple Fuel Pumps 140. Typically, a given Fuel Pump 140 would have only one instance of a Cash Card System 100 installed integral with, or operably connected to, it. A Customer User 120 will present an Identity Card 130 to be read by a card reader integral to, or a component of, Cash Card System 100. Upon approval of a transaction, a locking mechanism integral with, or operably connected to, the Fuel Pump 140 or Cash Card System 100 will unlock or provide an unlocking signal to an associated Fuel Pump 140. The Customer User 120 will typically operate the Fuel Pump 140 to fuel his/her motor vehicle. Further details of the above-described embodiment of the invention are discussed below with reference to FIGS. 2 and 3.

FIG. 2 is schematic system diagram depicting in one embodiment of the invention showing its major components. FIG. 2 in effect is an exploded schematic view of the black box depiction of Cash Card System 100 in FIG. 1. The system is broken down into two major areas: the customer-facing components and the back-office components. The customer-facing components include the Identity Product 130 and the Fuel Dispenser Assembly 210. The back-office components include the Central Computer 250 and the Database 260. The Fuel Dispenser Assembly 210 and the Central Computer are connected via a network 240, typically a wide-are network. Wide Area Network 240 is optionally the Internet, other public or private networks, or combinations thereof.

The communication of components through a common Wide Area Network 240 is illustrative only, and the invention includes embodiments where some entities communicate through one network, other entities through a different network, and various permutations thereof. The communication links between the network nodes preferably comprise a cable, fiber or wireless link on which electronic signals can propagate. For example, each node may be connected via an Internet connection using a public switched telephone network (PSTN), such as those provided by a local or regional telephone operating company. Alternatively, each node may be connected by dedicated data lines, cellular, Personal Communication Systems (“PCS”), microwave, or satellite networks. In other embodiments, the Database 260 is optionally connected over a network to the Central Computer 250, Fuel Dispenser Assembly 210, and/or sub-components thereof.

In this embodiment, the Identity product Reader 230 (also referenced as Card Reader) is a subcomponent of Fuel Dispenser Assembly 210, other embodiments are within the scope of the invention. In other embodiments, the Card Reader may be separate from, but in communication with, the Fuel Dispenser Assembly 210 or one or more sub-components thereof. In this depicted embodiment, a Identity Product 130 will be in communication with Identity Product Reader 230 by way of a customer placing the card into the reader, i.e., where the card has a magnetically encoded stripe and the card reader is configured to read a magnetically encoded stripe. All other known and unknown Identity Products 130 and Identity Product Readers 230 are intended to be within the scope of the invention. For example, the Identity Products 130 may optionally include radio signal transmitting devices that emit an encoded radio signal upon prompting by a radio signal Identity Product reader, known as RFID (radio frequency identification). Other embodiments printed bar codes on a card product and include a card having a computer chip embedded therein having data encoded therein and the Identity Product Reader 230 being capable of reading such data from the chip. The corresponding Identity Product Reader 230 for each of the above-described Identity Products 130 would be used.

Typically, the system will comprise a single or small number of Central Computers 250 and Database 260 or mirrors thereof and multiple Fuel Dispenser Assemblies 210 located remotely from the Central Computer 250 and Database 260. Alternatively, portions of, mirrors of, the Database or related information may be locally stored at the retail station, distributed, or otherwise structured as is known in the database arts. The Fuel Dispenser Assemblies are located at the retail fuel stations. The Identity Products 130 are carried by customers but become an active/connected part of the Cash Card System when a customer goes to a retail fuel station and presents the Identity Product to the Identity product reader 230.

The Database 260 optionally is a relational database having associated database management code segments for administrative management, reading, writing, updating, searching, and reporting from the Database. Known relational databases suitable for use with the Cash Card System include, e.g., Oracle 11i™ made by Oracle Corporation, DB2® made by IBM Corporation, or SQL Server® made by Microsoft Corporation. Database 260 is configured with relations for storing all identifying information, transaction records, a discount indicator, and a status indicator for each of the cash customers issued an identity product. The status indicator is used to approve or disapprove requested transactions. The cash customer's identifying information is related in the database to corresponding database key information encoded on each cash customer's issued Identity Product 130, where the database is in communication with the reader via a computer network 240. Database Update Code Segment 270 is configured to permit updating of any information stored in Database 260. Updates occur, e.g., after any transaction using the Identity Product 130. Transaction Approval Code Segment 280 is configured with business logic for approving or disapproving a transaction upon a customer presenting an Identity Product 130 to a Card Reader 230 to initiate a transaction. A high-level description of Transaction Approval Code Segment 280 discussed in the description of FIG. 3 below. Many various specific implementations of the above-described components are possible as will be understood by those skilled in the relevant arts associated with each component.

FIG. 3 is a level-0 data-flow diagram depicting in one embodiment of the invention the system's major processes and, where applicable, data flows and data stores at a high level. The process is initiated by Read Identity Card process 300 in which a Customer User 120 (FIG. 1) presents an Identity Product 130 (FIG. 2) to Identity Product Reader 230 (FIG. 2). The encoded identity information on the Identity Product 130 is read in a digital form and passed via Network 240 (FIG. 2) to Central Computer 250 (FIG. 2) for processing. In Transaction Approval Code Segment 280 (FIG. 2) the initial processing steps include Determine if Valid Card Process 310. In this process, one or more processes occur to validate the card. Where the Identity Product is a numbered card, these optionally include, e.g., verifying the card number's prefix, length, and any check digit are within a predetermined scope. If those tests are met, further tests can include verifying the card is properly registered and all customer information in Database 260 (FIG. 2) is in the proper format.

In another preferred embodiment, a portion of the Identity Product 130 validation occurs at the retail station in the Card Reader and/or a local processor integral with or connected to the Card Reader. For example the Card Reader is preferably integral with or connected to a point of sale processing terminal which includes a central processor or an application-specific integrated circuit (ASIC). Alternatively, the Card Reader, point of sale terminal, or both may be connected to a local general purpose computer (not shown) having a code segment loaded thereon for performing initial steps for validating the Identity Product, e.g., verifying a bin range or check digit. If such validation steps are passed, then the Identity Product information is passed over a Network 240 to a Central Computer 250 for further validation steps, e.g., verifying card is active, properly registered, and/or in good standing.

If the Determine if Valid Card Process 310 is failed, control passes to Disapprove Transaction Process 320. If passed, control is then passed to Determine if Status Indicator Set Process 325. In this process, the Database 260 is read to determine the state of the Status Indicator variable or its equivalent. A Status Indicator may be used as an attribute of the customer's record for indicating whether the account is in good standing, e.g., all purchases have been fully paid. It is arbitrary whether being “set” is predetermined to indicate the customer is in good standing or not in good standing so long as it is consistently used.

If the Determine if Status Indicator Set Process 325 is failed, control passes to Disapprove Transaction Process 320. If passed, control passes to Read Discount Indicator Process 330. A Discount Indicator may be used as an attribute of the customer's record for indicating any discount for which customer is eligible. A wide variety of pre-determined discount structures/algorithms may be applied as viewed appropriate for motivating the customer to use a Cash Card versus other form of payment. The discount structure can be tailored by retail station location, customer profile, or other factors. For example, a predetermined discount structure might include a stair step approach where the customer receives increasing discounts upon reaching predetermined purchase volumes within predetermined time periods. Alternatively, a random “Monte Carlo” type discount might be used wherein discounts are randomly applied and range from smaller to larger. All other discount algorithms are within the scope of the invention.

A Discount Indicator of zero could indicate no discount is applicable. Preferably, retail station owners may implement their own discount schedule/algorithm for their location independent of any discount schedules/algorithms used by other stations. This can be achieved, e.g., by including a retail station indicator in the transaction approval request. If approved, the retail station indicator can be used as a key to, e.g., a discount schedule look-up table or relation or other known or unknown database structure. A single customer optionally may have a separate discount indicator for each retail station at which he/she buys fuel. Alternatively, the discounts could be region-wide and the discount indicator could be set to be adjusted based on all aggregated transactions within a region.

The read Discount Indicator is sent from the Read Discount Indicator Process 330 to the Adjust Pricing per Discount Indicator Process 335. There the Discount Indicator will be processed in, e.g., an algorithm, look-up table, or other suitable data structure or business logic to associate the Discount Indicator with a price. A look-up table is particularly suitable since it is easily updated with current fuel pricing which changes frequently. Alternatively, the Discount Indicator is a percentage or monetary amount that is processed directly at the Fuel Dispenser Assembly 210 to determine the final fuel price. The output fuel price and/or Discount Indicator are sent from Central Computer 250 via Network 240 to Fuel Dispenser 210 and in particular to Unlock Locking Mechanism Process 340. Alternatively, Unlock Locking Mechanism Process 340 is located in Central Computer 250 and only the output, e.g., an unlocking indicator, is sent to Fuel Dispenser 210. The Transaction Locking Device 220 receives the unlock indicator, unlocks the fuel pump, the fuel is pumped by the customer, and the transaction is completed.

In an alternate preferred embodiment, the Read Discount Indicator Process 330 and/or the Adjust Pricing per Discount Indicator Process 335 are processed in part or in total at the retail station. That is, as described above regarding the Identity Product validation process, which is incorporated herein by reference in its entirety, the Read Discount Indicator Process 330 and/or the Adjust Pricing per Discount Indicator Process 335 may be processed in whole or in part via an integral ASIC in a point of sale terminal or via a suitable code segment in a local general purpose computer at the retail station. For example, a certain discount may apply to all Cash Cards used for a given retail station without regard to a customer's transaction history. Also, or separately, a discount may also be applied based on a customer's transaction history, as described above. Thus, the Read Discount Indicator Process 330 and/or the Adjust Pricing per Discount Indicator Process 335 may be processed locally, remotely, or some combination thereof.

Update Transaction Records Process 345 then operates to pass the transaction details via Network 240 to Database Update Code Segment 270. There, the customer's record in Database 260 is updated with the new transaction information or pre-determined portions thereof. This information may be used to adjust the Discount Indicator for the customer's next purchase, if applicable, in Update Discount Indicator Process 355.

Whether manually or automated, Determine if Purchase Paid in Full Process 350, validates the purchase was paid in full. If not, a message is sent to Database Update Code Segment 270 to update the customer's record in Change the State of Status Indicator Process 360. This is used in earlier step 325 in the next attempted transaction to disapprove the transaction is step 320 if pre-determined default criteria are met, e.g., no further purchases permitted upon two defaults in payment.

While the depicted embodiment in FIG. 2 shows a distributed system with a Central Computer and multiple remote Fuel Dispenser Assemblies 210 communicating over a Wide Area Network 240, other variations are within the scope of the invention. For example, the Database 260 and Central Computer 250 could be co-located with the Fuel Dispenser Assemblies 210 at the same retail fuel station or clusters of a small number of retail stations may use a regionally located Central Computer 250 in communication over, e.g., a metropolitan area network or even a Local Area Network in a dense city environment with multiple retail stations in close proximity.

### Other Implementation Details

Terms

The detailed description contained herein is represented partly in terms of processes and symbolic representations of operations by a conventional computer. The processes and operations performed by the computer include the manipulation of signals by a processor and the maintenance of these signals within data packets and data structures resident in one or more media within memory storage devices. Generally, a “data structure” is an organizational scheme applied to data or an object so that specific operations can be performed upon that data or modules of data so that specific relationships are established between organized parts of the data structure.

A “data packet” is a type of data structure having one or more related fields, which are collectively defined as a unit of information transmitted from one device or program module to another. Thus, the symbolic representations of operations are the means used by those skilled in the art of computer programming and computer construction to most effectively convey teachings and discoveries to others skilled in the art.

For the purposes of this discussion, a process is generally conceived to be a sequence of computer-executed steps leading to a desired result. These steps generally require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to representations of these signals as bits, bytes, words, information, data, packets, nodes, numbers, points, entries, objects, images, files or the like. It should be kept in mind, however, that these and similar terms are associated with appropriate physical quantities for computer operations, and that these terms are merely conventional labels applied to physical quantities that exist within and during operation of the computer.

It should be understood that manipulations within the computer are often referred to in terms such as issuing, sending, altering, adding, disabling, determining, comparing, reporting, and the like, which are often associated with manual operations performed by a human operator. The operations described herein are machine operations performed in conjunction with various inputs provided by a human operator or user that interacts with the computer.

Hardware

It should be understood that the programs, processes, methods, etc. described herein are not related or limited to any particular computer or apparatus, nor are they related or limited to any particular communication architecture. Rather, various types of general-purpose machines may be used with program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read only memory.

Program

In the preferred embodiment, the steps of the present invention are embodied in machine-executable instructions. The instructions can be used to cause a general-purpose or special-purpose processor that is programmed with the instructions to perform the steps of the present invention. Alternatively, the steps of the present invention might be performed by specific hardware components that contain hardwired logic for performing the steps, or by any combination of programmed computer components and custom hardware components.

The foregoing system may be conveniently implemented in a program or program module(s) that is based upon the diagrams and descriptions in this specification. No particular programming language has been required for carrying out the various procedures described above because it is considered that the operations, steps, and procedures described above and illustrated in the accompanying drawings are sufficiently disclosed to permit one of ordinary skill in the art to practice the present invention.

Moreover, there are many computers, computer languages, and operating systems that may be used in practicing the present invention and therefore no detailed computer program could be provided which would be applicable to all of these many different systems. Each user of a particular computer will be aware of the language and tools that are most useful for that user's needs and purposes.

The invention thus can be implemented by programmers of ordinary skill in the art without undue experimentation after understanding the description herein.

Product

Any software-implementable aspect of the present invention may be provided as a computer program product that may include a machine-readable medium having stored thereon instructions that may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, or other type of media/machine-readable medium suitable for storing electronic instructions. Moreover, the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

Components

The major components (also interchangeably called aspects, subsystems, modules, functions, services) of the system and method of the invention, and examples of advantages they provide, are described herein with reference to the figures. For figures including process/means blocks, each block, separately or in combination, is alternatively computer implemented, computer assisted, and/or human implemented. Computer implementation optionally includes one or more conventional general purpose computers having a processor, memory, storage, input devices, output devices and/or conventional networking devices, protocols, and/or conventional client-server hardware and software. Where any block or combination of blocks is computer implemented, it is done optionally by conventional means, whereby one skilled in the art of computer implementation could utilize conventional algorithms, components, and devices to implement the requirements and design of the invention provided herein. However, the invention also includes any new, unconventional implementation means.

Other Implementations

Other embodiments of the present invention and its individual components will become readily apparent to those skilled in the art from the foregoing detailed description. As will be realized, the invention is capable of other and different embodiments, and its several details are capable of modifications in various obvious respects, all without departing from the spirit and the scope of the present invention. Accordingly, the drawings and detailed description are to be regarded as illustrative in nature and not as restrictive. It is therefore not intended that the invention be limited except as indicated by the appended claims. For example, the invention includes a Identity Product that is only used to permit a customer to make a cash purchase without pre-paying or an Identity Product that still requires pre-payment but allows for cash customer discounts, and combinations thereof.

What is claimed is:

1. A system for increasing convenience and reducing cost for cash fuel purchases comprising:
(a) an identity product for issuance to cash customers and having machine-readable database key information encoded therein;
(b) a reader for reading the machine-readable database key information encoded on the identity product;
(c) a database for storing identifying information, transaction records, a discount indicator, and a status indicator for each of the cash customers issued an identity product, wherein the status indicator is used to approve or disapprove requested transactions, wherein each of the cash customer's identifying information is related in the database to the corresponding database key information encoded on each cash customer's issued identity product, wherein the database is in communication with the reader via a computer network;
(d) a transaction locking device for allowing a transaction to proceed upon unlocking;
(e) a transaction approval code segment loaded on a general purpose computer in communication with the reader via a network, the code segment adapted and configured for receiving a database key, passing it to the database, receiving the identifying information and status indicator, and approving or disapproving a transaction based on the status indicator, and passing the approval or disapproval to the transaction locking device, wherein the transaction locking device only unlocks upon receiving a transaction approval; and
(f) a database update code segment loaded on the general purpose computer, the code segment adapted and configured for updating the transaction records with the most recent transaction, and updating the status indicator in the database for each customer after each transaction, wherein upon after a pre-determined number of transactions having payment defaults the status indicator is updated to a pre-determined indicator to cause a transaction disapproval upon the next transaction request, and updating the discount indicator wherein upon predetermined transaction criteria, the transaction indicator is updated to a pre-determined indicator to cause the price per unit of fuel to change for the next requested transaction.

2. The system of claim 1, wherein the identity product is a card having a magnetically encoded stripe thereon.

3. The system of claim 1, wherein the identity product is a card having a bar code printed thereon.

4. The system of claim 1, wherein the identity product is a radio frequency identification product.

5. The system of claim 1, wherein the steps occur in substantially real-time.

6. The system of claim 1, wherein the network comprises the Internet.

7. The system of claim 1, wherein the network comprises a virtual private network.

8. The System of claim 1, wherein the database is a relational database.

9. A method for increasing convenience and reducing cost for cash fuel purchases comprising:
(a) reading an identity product for issuance to fuel cash customers and having machine-readable database key information encoded therein;
(b) passing the database key information over a network to a database for storing identifying information, transaction records, a discount indicator, and a status indicator for each of the cash customers issued an identity product, wherein the status indicator is used to approve or disapprove requested transactions, wherein each of the cash customer's identifying information is related in the database to the corresponding database key information encoded on each cash customer's issued identity product, wherein the database is in communication with the reader via a computer network;
(c) receiving the status indicator over the network from the database by a transaction approval code segment loaded on a general purpose computer, the code segment adapted and configured for receiving a database key, passing it to the database, receiving the identifying information and status indicator, and approving or disapproving a transaction based on the status indicator, and passing the approval or disapproval to a transaction locking device, wherein the transaction locking device only unlocks upon receiving a transaction approval;
(d) unlocking the transaction locking device, thereby permitting the purchase of fuel by the cash customer; and
(e) updating a database update code segment with the purchase information, wherein the database update code segment is loaded on the general purpose computer, the code segment adapted and configured for updating the transaction records with the most recent transaction, and updating the status indicator in the database for each customer after each transaction, wherein upon after a pre-determined number of transactions having payment defaults the status indicator is updated to a pre-determined indicator to cause a transaction disapproval upon the next transaction request, and updating the discount indicator wherein upon pre-determined transaction criteria, the transaction indicator is updated to a pre-determined indicator to cause the price per unit of fuel to change for the next requested transaction.

10. The method of claim 9, wherein the identity product is a card having a magnetically encoded stripe thereon.

11. The method of claim 9, wherein the identity product is a card having a bar code printed thereon.

12. The method of claim 9, wherein the identity product is a radio frequency identification product.

13. The method of claim 9, wherein the steps occur in substantially real-time.

14. The method of claim 9, wherein the network comprises the Internet.

15. The method of claim 9, wherein the network comprises a virtual private network.

16. The method of claim 9, wherein the database is a relational database.
